(19) United States
(12) Patent Application Publication
(10) Pub. No.: US 2024/0211334 A1
(43) Pub. Date: Jun. 27, 2024

(54) SELECTIVE DIAGNOSTIC DUMPING OF MEMORY CONTENTS BASED ON TRACKING MEMORY USE

(71) Applicant: International Business Machines Corporation, Armonk, NY (US)

(72) Inventors: Scott B. COMPTON, Hyde Park, NY (US); Elpida TZORTZATOS, Lagrangeville, NY (US); Purvi Sharadchandra PATEL, Rock Hill, SC (US); Christine Michele YOST, Hopewell Junction, NY (US)

(21) Appl. No.: 18/146,882

(22) Filed: Dec. 27, 2022

(51) Int. Cl. G06F 11/07

(52) U.S. Cl. CPC G06F 11/0778; G06F 11/076; G06F 11/0784

(57) ABSTRACT

Techniques for selective memory dumping based on tracking memory use. For each set of contiguous frames of memory, whether a reference bit is set is determined. The reference bit is included in a control field of a frame of the respective set. Each set has an associated mapping from corresponding pages of a virtualized address space. An unreferenced-interval count is maintained for the respective set. The unreferenced-interval count represents an age since any frame of the respective set was last accessed. The unreferenced-interval count and the reference bit are cleared upon determining that the reference bit is set. If the unreferenced-interval count of a set does not exceed a threshold count, the set is included in a diagnostic dump of the memory when a condition for generating the diagnostic dump is met.

### BACKGROUND

Embodiments presented in this disclosure relate to techniques for generating memory dumps. More specifically, embodiments disclosed herein relate to selective diagnostic dumping of memory contents based on tracking memory use.

In modern data processing systems, or computers, an operating system manages the distribution of system resources to one or more executing software applications. A fundamental component of operating systems is the operating system kernel, which provides software applications with secure access to the system resources. Processes running in user space do not have permission to utilize system resources on their own. Operating systems provide entry points through system calls, which may be implemented using software interrupts, that allow user-space processes to request services from the kernel. Thus, these processes make predefined calls to the operating system to request resources from the operating system. The processes may be configured to make calls directly or by making calls to an application program interface (API) that implements system calls. System calls and API calls may be implemented differently on various operating systems or on different versions of the same operating system.

### SUMMARY

Embodiments presented in this disclosure provide a computer-implemented method, a computer program product, and a system to perform an operation of selective memory dumping based on tracking memory use. The operation includes determining, for each of set of contiguous frames of memory, whether a reference bit is set. The reference bit is included in a control field for a frame of the respective set. Further, each set has an associated mapping from a corresponding plurality of pages of a virtualized address space.

The operation also includes maintaining, for each set of contiguous frames and based on the reference bit for the respective set, an unreferenced-interval count that represents an age since any frame of the respective set was last accessed. The unreferenced-interval count and the reference bit are cleared upon determining that the reference bit is set. The operation also includes determining that a condition for generating a diagnostic dump of the memory is met. The operation also includes, upon determining that the unreferenced-interval count of a set does not exceed a threshold count, including the set in the diagnostic dump.

### BRIEF DESCRIPTION OF THE DRAWINGS

FIG. 1 is a block diagram depicting a computing environment for selective diagnostic dumping of memory contents based on tracking memory use, according to one embodiment presented in this disclosure.

FIG. 2 is a flowchart depicting a method for selective diagnostic dumping of memory contents based on tracking memory use, according to one embodiment presented in this disclosure.

FIG. 3 is a flowchart depicting a method for tracking memory use to facilitate selective diagnostic dumping, according to one embodiment presented in this disclosure.

FIG. 4 is a flowchart depicting a method for selective diagnostic dumping of memory contents based on tracked memory use, according to one embodiment presented in this disclosure.

FIG. 5 is a block diagram illustrating components of a computing environment for selective diagnostic dumping of memory contents based on tracking memory use, according to one embodiment presented in this disclosure.

### DETAILED DESCRIPTION

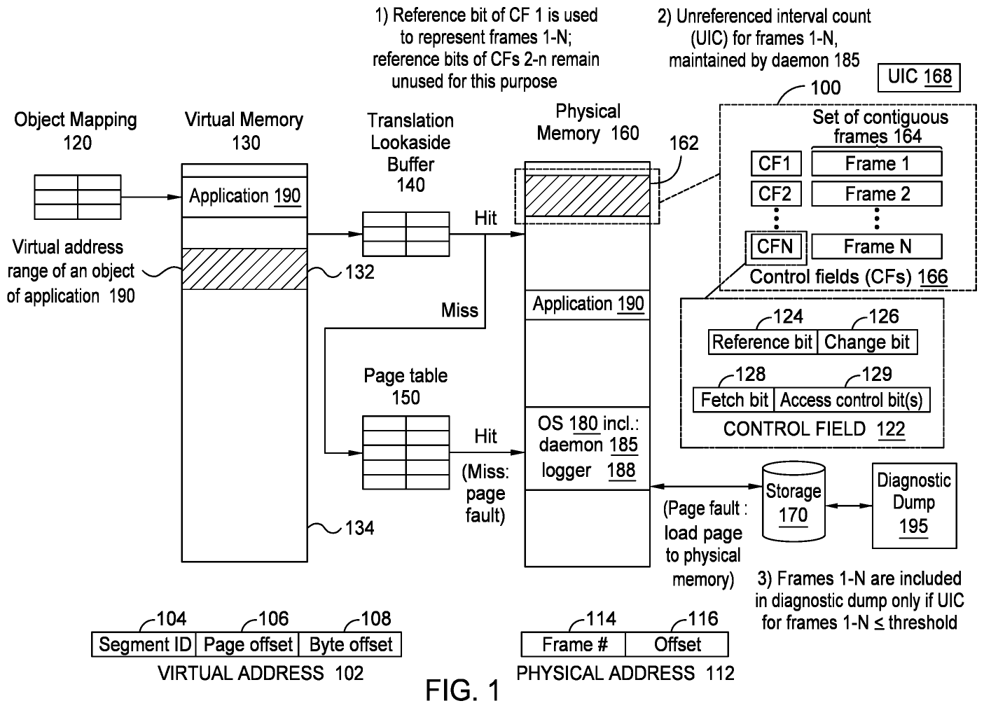

Embodiments presented in this disclosure provide techniques for selective diagnostic dumping of memory contents based on tracking memory use. Referring to FIG. 1, a functional block diagram 100 is shown to depict a computing environment for selective diagnostic dumping of memory contents based on tracking memory use, according to one embodiment. The functional block diagram 100 includes a storage 170, physical memory 160 addressable via physical address 112, and virtual memory 130 addressable via virtual address 102. In a particular embodiment, the virtual address 102 includes a segment identifier 104 and an offset that includes both a page offset 106 and a byte offset 108, whereas the physical address 112 includes a frame number 114 and an offset 116. The segment identifier 104 and the page offset 106 together can be referred to as a virtual page number of the virtual address. Each frame in physical memory 160 has an associated control field 122. The control field can also be referred to as a storage key.

At least in some embodiments, the techniques presented herein are performed by an operating system 180 that implements memory management by virtualizing memory units of a computer as the virtual memory 130, to permit applications, such as application 190, to access the memory units as if there was a single, contiguous hardware memory unit. As shown, the operating system 185 is loaded in the physical memory 160, while the application 190 is loaded in the physical memory 160 and has a corresponding address range in the virtual memory 130.

In some embodiments, the operating system 180 includes a kernel that, due to the complexities involved in accessing hardware, implements a set of hardware abstractions to provide a uniform interface to the underlying hardware, thereby simplifying software application development. The operating system 180 can segregate the virtual memory 130 into user space, which is designated for executing user applications, and kernel space, which is reserved for running the kernel and extensions to the kernel.

Depending on the embodiment, the techniques presented herein can be performed by one or more components of the operating system 180, such as a daemon 185 and a logger 188, and/or by one or more components of the application 190. The logger can also be referred to as a logging component, a system dump processor, a dump processor, or a dumper. In certain embodiments, the techniques presented herein can be distributed across different components and/or programs. For instance, in a particular embodiment that is described with reference to the figures, one component of the operating system 180—namely, the daemon 185 as a background process—tracks and maintains memory accesses, while another component of the operating system 180—namely, the logger 188 as a separate process—handles memory dumping based on the tracked accesses. Other embodiments, however, are broadly contemplated, including embodiments in which the functionality described herein is performed by a single component of the operating system 180 or by the operating system 180 itself.

In some embodiments, the kernel can include a virtual memory manager component configured to maintain a subset of secondary storage space on the storage 170 for temporarily storing content that the physical memory 160 is currently insufficient or otherwise unavailable to store. The subset of secondary storage space is referred to as paging space. The virtual memory manager swaps content from the physical memory 160 to the paging space in the storage 170 when the content is not in use. The virtual memory manager also swaps content from the paging space in the storage 170 back into the physical memory 160 when the content is once again in use. The content can be read to or written from the paging space in the form of blocks of contiguous paging space, also referred to as pages.

In this way, the memory management, also referred to as virtual memory management, permits total memory content of processes executing on a computer to exceed the total physical memory and further permits the processes to use the physical memory 160 only when the processes are actually executing. The operating system 180 can attempt to free up, or deallocate, pages from the processes before the operating system runs out of available memory, to avoid deadlocks that can cause the operating system 180 to crash. For instance, the operating system 180 can maintain operating system stability by terminating a process to which an excessive number of pages are allocated.

At least in some embodiments, the operating system 180 provides a virtual instruction set that is independent of an underlying machine instruction set supported by one or more computer processors of a system represented by the functional block diagram 100. The virtual instruction set can be implemented via microcode components of the operating system 180 and can be referred to as a technology-independent machine interface or virtual-machine interface. Applications using the technology-independent machine interface can be insulated from changes to the underlying processor architecture, such as those resulting from advances in processor design. In one embodiment, applications written in a high-level programming language are compiled to the virtual instruction set and then further compiled to the underlying machine instruction set. In an alternative embodiment, the applications are compiled to the virtual instruction set and then interpreted to generate and execute machine instructions.

In some embodiments, the applications obtain, from the operating system 180, memory allocations in the form of address ranges in virtual memory 130. These address ranges are referred to as memory objects; the memory objects are also referred to as objects or system objects. In some embodiments, as applications obtain memory via requests to the operating system, some of the obtained memory can contain data that can be desired as being relevant for troubleshooting issues relating to the application. On the other hand, other portions of the obtained memory can contain data that is not deemed as being relevant for troubleshooting issues relating to the application and, as such, data that is not desired for such troubleshooting purposes. At least in some embodiments, the obtained memory can be in the form of memory objects provided by the operating system to the requesting applications.

In some embodiments, the computing environment includes the object mapping 120, which contains information used to address each memory object. The system objects may be addressable via: object name, object type, and object subtype. Additionally or alternatively, each memory object can be addressable via a virtual address 102. When a memory object is deleted, its virtual address is no longer valid, and an attempt by an application to access the virtual address results in an object-destroyed exception. Support for the object-destroyed exception permits object access via virtual address while still maintaining integrity of virtual memory accesses and, consequently, integrity of the execution environment provided by the operating system 180. The virtual addresses referencing the segment pages contain a segment identifier that is de-assigned when the segment is destroyed, thereby rendering the segment virtual addresses invalid and providing support for the object-destroyed exception. The segment identifier can be de-assigned by updating the object mapping 120 to reflect the segment identifier as being de-assigned.

In one embodiment, the computing environment provides a page table 150 is that contains mapping information from virtual addresses of the virtual memory 130 to physical addresses of the physical memory 160. A successful lookup of a given virtual address in the page table 150 yields a corresponding physical address. On the other hand, an unsuccessful lookup triggers a page fault, whereupon the virtual memory manager component loads a desired page from the storage 170 to the physical memory 160 at a specific physical address; the page table 150 is updated to reflect the specific physical address.

In some embodiments, the computing environment provides a translation lookaside buffer 140 that serves as a cache for the page table 150. The translation lookaside buffer 140 can be implemented in hardware cache memory. Depending on the embodiment, this hardware cache memory can reside between a processing unit of a processor and a cache component of the processor; between the processor and main memory; or between different levels of cache components of the main memory.

In one embodiment, when a lookup of a given virtual address is desired, the virtual memory manager component first checks the translation lookaside buffer 140. A successful lookup of the given virtual address in the translation lookaside buffer 140 yields a corresponding physical address. If the lookup is unsuccessful, the virtual memory manager component then performs a lookup in the page table; main-memory access occurs if the page table lookup is successful, while secondary-storage access occurs if the page table lookup triggers a page fault. Whether a page fault is triggered, the corresponding physical address is identified, the translation lookaside buffer is updated to reflect the given virtual address and the corresponding physical address.

Although only a single level of translation from virtual address 102 to physical address 112 is shown in the functional block diagram 100 for illustrative purposes, in alternative embodiments, additional levels of translation of virtual addresses can be performed. In a particular embodiment, an effective virtual address, specific to a process or to the kernel, is translated to a system virtual address specific to the overall system; the system virtual address is then translated to a physical address. The effective virtual address can be smaller in size than the system virtual address and can include an effective segment identifier, a page offset, and a byte offset; the system virtual address can include a virtual segment identifier, a page offset, and a byte offset. The effective virtual address can be translated to the system virtual address via information stored and maintained in a segment table separate from the page table 150. At least in some embodiments, the object mapping 120, the page table 150, and/or the segment table can be stored and maintained in kernel space of the virtual memory 130.

In one embodiment, the control field 122 associated within a given frame in the physical memory 160 includes a reference bit 124, a change bit 126, a fetch bit 128, and one or more access control bits 129. At least in some embodiments, the control field 122 is maintained by the hardware logic of one or more computer processors of the system. At least in some embodiments, the reference bit 124 and the change bit 126 are used to implement the virtual memory 139.

The reference bit 124 indicates whether the given frame has been referenced since the last time that the reference bit 124 was cleared, according to one embodiment. The change bit 126 indicates whether the given frame has been altered since the last time that the change bit 126 was cleared. The fetch bit 124 controls whether protection is extended to cover read operations involving the given frame, i.e., in addition to covering write operations involving the given frame. The one or more access control bits 129 describe one or more protection keys that are associated with the page that is, in turn, associated with the given frame. In some embodiments, the control field 122 can also include one or more unused bits.

In one embodiment, as memory sizes on computer systems continue to grow, it can become increasingly difficult to capture diagnostic information when errors occur in processing. Larger diagnostic dumps can be costly, as such dumps can take up a significant amount of memory. Further, such dumps can use significant compute and input/output (I/O) resources when capturing the dumps from memory and writing the dumps to external storage such as disk or tape. In addition, such dumps can also occupy a significant amount of space in external storage. Further, in many cases, and especially with larger dump sizes, before a dump is captured, processes executing on the computer systems may first need to be quiesced to ensure that the captured dump reflects a consistent memory-state.

Moreover, transmitting the diagnostic dump after the diagnostic dump has been written can also be costly in terms of processing overhead, network bandwidth, and/or time, according to one embodiment. For instance, the diagnostic dump can be transferred from a user of a product to a vendor of the product or an affiliated party therewith for analysis, such as pursuant to a service request or a bug report from the user. Depending on the embodiment, the product can be a given application, the operating system, and/or a hardware component of the system.

In one embodiment, as memory is referenced or changed, hardware logic of the one or more computer processors maintains indicators in the storage key associated with the affected memory. The indicators can include the reference bit and the change bit. These indicators can be maintained in increments of a frame size of four kilobytes; that is, each frame having a size of four kilobytes has an associated storage key for the entire frame. The operating system 180 can be configured to maintain an unreferenced-interval count (UIC) based on the reference bit being on for each page backed by a real frame having a size of four kilobytes.

As the amount of available memory has increased over time, some operating systems may have stopped using the reference bit to maintain least recently used (LRU) metrics for each frame, because the processing overhead of doing so has become too significant. In one embodiment, for virtualized address spaces of a threshold size or greater, the operating system 180 can be configured to use the reference bit in the storage key for the first frame of a set of contiguous frames. The set of contiguous frames can also be referred to as a collection of contiguous frames; this set can also be referred to as a larger frame or a “large frame”. For instance, for a frame having a size of four kilobytes, the set of contiguous frames can have a size of one megabyte or two gigabytes. The reference bit can be used by the operating system 180 to determine an age of the set of contiguous frames. The reference bit can also be used by the operating system 180 to determine and represent an extent to which a set of pages that map to the frames in the set of contiguous frames has been unreferenced since a previous point in time, such as a time of last inquiry.

The extent can be represented in the form of a count associated with the set of contiguous frames, where the count is of unreferenced intervals, according to one embodiment. The count is also referred to as an unreferenced-interval count for the set of contiguous frames. One such unreferenced-interval account is depicted as UIC 168, which pertains to the set of contiguous frames 164, each of the contiguous frames having a respective control field (CF), or storage key, of control fields 166. At least in some embodiments, the unreferenced-interval count can be maintained at a level of a set of frames rather than at a level of an individual frame. Additionally or alternatively, in some embodiments, the unreferenced-interval count is maintained only for private memory objects and/or shared memory objects, that are backed by larger frames. Doing so lowers a frequency with which the unreferenced-interval count is maintained in the system, thereby advantageously reducing an adverse impact on performance of the system.

In one embodiment, the one or more computer processors are designed or redesigned to maintain, for each set of contiguous frames, only a single one of the reference bits of the storage keys of the respective set of contiguous frames. In this regard, a large frame having a size of two gigabytes can have 2048 associated reference bits, while a large frame having a size of one megabyte can have 256 associated reference bits. In some embodiments, the single reference bit can be the first reference bit, such as CF 1 of control fields 166. The first reference bit refers to the reference bit associated with the frame having the lowest physical memory address among the frames in the set, according to one embodiment. In other embodiments, another reference bit, such as the last reference bit or any reference bit in between the first and last reference bits, can be used as the single reference bit.

The one or more computer processors are designed or redesigned such that any reference to a memory location within a set of contiguous frames causes the one or more computer processors to set the single reference bit, according to one embodiment. Advantageously, using only the storage key of the first frame in the set of contiguous frames permits the operating system 180 to avoid incurring a processing overhead associated with scanning all associated storage keys just to inspect a respective reference bit in each of those associated storage keys, at least in some cases.

For instance, the operating system 180 can avoid scanning 256 storage keys for a large frame having a size of one megabyte or, alternatively, 2048 storage keys for a large frame having a size of two gigabytes. The first frame in the set refers to the frame, in the set of contiguous frames, having the lowest physical memory address among the frames in the set, according to one embodiment. As shown, the operating system 180 can scan CF 1 of the control fields 166 to determine a measure of memory use of frames 1-N of the set of contiguous frames 164, where N represents an integer. Doing so avoids incurring a processing overhead of scanning CFs 2-N of the control fields 166.

In one embodiment, during a diagnostic memory dump, the operating system 180 performs a capture operation that takes into account the respective unreferenced-interval count of each set of contiguous frames. The capture operation can operate in different modes of operation, based on one or more options. The one or more options can be preconfigured to default values and/or set based on user input. The modes include one or more of a selective-dumping mode, a dual-dumping mode, and/or a full-dumping mode, according to one embodiment. Generally, the operating system 180 generates and outputs one or more diagnostic dumps, such as the diagnostic dump 195.

In one embodiment, in the selective-dumping mode, the operating system 180 refrains from dumping any frame of a given set of contiguous frames if the operating system 180 determines that the given set is accessed infrequently based on a predefined threshold. Depending on the embodiment, the predefined threshold can be a threshold frequency or a threshold count. Such frames that the operating system 180 refrains from dumping are referred to as excluded frames or skipped frames, while a set that the operating system 180 refrains from dumping is referred to as an excluded set or a skipped set.

The determination can include evaluating whether the unreferenced-interval count for the given set exceeds a threshold count, according to one embodiment. In an alternative embodiment, the threshold count need not necessarily be exceeded but need just be met. The operating system 180 can refrain from dumping any frame of the given set when the unreferenced-interval count exceeds the threshold. At least in some embodiments, the determination can also include evaluating whether the object that the set of contiguous frames belongs to is of one or more specified types of object for which evaluation is required, e.g., a private system object or a shared system object. In some embodiments, this evaluation can occur prior to evaluating the unreferenced-interval count and in a short-circuit manner relative to the latter evaluation. In this regard, if the object does not belong to any of the one or more specified types, dumping of the object can be forcibly performed without any further evaluation or, alternatively, forcibly skipped without any further evaluation.

At least in some embodiments, a request for a dump can specify criteria of memory that is desired to be captured. The criteria can be specified in the form of one or more parameters supplied with the request or otherwise associated with the request (e.g., system parameters). The operating system 180 can then generate the dump based on the specified criteria. For example, the operating system 180 can determine lists of memory addresses for capture, directly or indirectly based on the one or more parameters. In this regard, a first list of memory addresses can be supplied as a parameter with the request, while a second list of memory addresses can be determined based on a system parameter as of a time at which the request is received. In some embodiments, the operating system 180 can additionally capture trace data characterizing one or more system areas designed as key system-areas and/or one or more control blocks of the system that are designated as major control-blocks. Further, a type of the capture operation for the requested dump can be determined directly or indirectly from the specified criteria, according to one embodiment.

In some embodiments, the operating system 180 can support different types of the capture operations, such as a faster capture operation involving copying within memory and a slower capture operation that includes I/O operations involving persistent storage. The copying within memory entails copying memory contents to a different memory location, thereby avoiding I/O operations. The different memory location can be of memory area designated as a memory-capture copy-destination. In some embodiments, the specific dump-capture operation that is performed depends on a type of dump that is requested. For system dumps, the type of capture operation that involves copying within memory can be used at least initially, which allows I/O operations for writing the dump to storage media to be deferred until all relevant memory is captured to the memory-capture copy-destination. At least in some embodiments, neither the full diagnostic dump nor the skipped diagnostic dump is generated in the selective-dumping mode.

In one embodiment, in the dual-dumping mode, the operating system 180 generates at least two diagnostic dumps. For instance, the operating system 180 generates the selective diagnostic dump while also dumping each frame of a given set of contiguous frames even if the operating system 180 determines that the given set is accessed infrequently based on the predefined threshold. However, each frame of the given set can be dumped into a separate dump file relative to the selective diagnostic dump. The selective diagnostic dump is the diagnostic dump file used for dumping frames of sets that are accessed frequently based on the predefined threshold, according to one embodiment.

More specifically, in one embodiment, the two diagnostic dumps include a selective diagnostic dump that only contains each frame of each set of contiguous frames, where the respective set is accessed frequently based on the predefined threshold. The two diagnostic dumps further include a full diagnostic dump that contains each frame of each set of contiguous frames regardless of the frequency with which the respective set is accessed.

Depending on the embodiment, unlike the selective diagnostic dump, the separate diagnostic dump in the dual-dumping mode can contain excluded frames only or, alternatively, all frames. A separate diagnostic dump containing only excluded frames is referred to as an excluded diagnostic dump, a skipped diagnostic dump, or a remainder diagnostic dump. Alternatively, a separate diagnostic dump containing all frames is referred to as a full diagnostic dump, a complete diagnostic dump, an unselective diagnostic dump, or an indiscriminate diagnostic dump. The dumping of the excluded frames and/or all frames can include a capture operation that involves copying the frames to another memory location. In some embodiments, the given set has associated metadata, where the metadata includes the unreferenced interval count of the given set, and the capture operation can capture the metadata along with the given set.

At least when compared to the selective-dumping mode, the dual-dumping mode uses a greater amount of space in persistent storage in return for an advantage of capturing memory contents in a more complete manner in case such an extent of memory capture is needed for a desired purpose, such as for troubleshooting a specified program, according to one embodiment. Under the technique, the selective diagnostic dump can be transmitted first, while the complete diagnostic dump can be transmitted second and only if necessary. At least in some cases, if the selective diagnostic dump contains information sufficient for troubleshooting the program, there could be no need to transmit the complete diagnostic dump, and an overhead in terms of compute and/or network resources can be avoided. In this way, excluding aged memory-locations from the selective diagnostic dump can lower a processing overhead associated with dumping and, as a result, lower a memory requirement associated with performing capture processing, at least in some cases.

In one embodiment, in the full-dumping mode, the operating system 180 dumps each frame of each set of contiguous frames regardless of whether the unreferenced-interval count of the respective set exceeds the predefined threshold. Put another way, the operating system 180 generates a full diagnostic dump. At least in some embodiments, neither the selective diagnostic dump nor the remainder diagnostic dump is generated in the full-dumping mode. In some embodiments, the operating system 180 manages frames such that every frame belongs in a respective set of contiguous frames. In an alternative embodiment, however, the operating system 180 manages frames such that certain frames do not belong to any set of contiguous frames even though other frames do belong to a set. The frames that do not belong to any set are referred to as discrete frames and can by default be included or excluded from diagnostic dumps.

Depending on the embodiment, unlike the selective diagnostic dump, the separate dump file in the dual-dumping mode can contain excluded frames only or, alternatively, all frames. The dumping can include a capture operation that involves copying the frames to another memory location. In some embodiments, the given set has associated metadata, where the metadata includes the unreferenced interval count of the given set, and the capture operation can capture the metadata along with the given set.

In one embodiment, the operating system 180 includes the daemon 185, which is configured to evaluate the reference bits and maintain unreferenced-interval counts for sets of contiguous frames. In some embodiments, the functionality of the daemon 185 is performed only on memory objects that are designated as being backed by a set of contiguous frames, the set having a size of one megabyte or, alternatively, two gigabytes.

When the daemon 185 detects that a reference bit is set for a given set of contiguous frames that is being monitored, the daemon 185 clears the unreferenced-interval count for the given set, according to one embodiment. The daemon 185 also clears the reference bit. On the other hand, when the daemon 185 detects that the reference bit is cleared for a given set of contiguous frames that is being monitored, the daemon 185 increments the unreferenced-interval count for the given set. In this manner, over time, pages that are less frequently accessed will map to frames of sets having higher unreferenced-interval counts.

In some embodiments, to reduce a processing overhead of the daemon 185 and/or of the logger 188, some or all of the functionality described herein can be skipped for memory objects that are created with an option enabled, the option specifying to force dumping to be skipped. Additionally or alternatively, some or all of the functionality described herein can be skipped for memory objects that are created with an option enabled, the option specifying to force dumping to occur.

In one embodiment, the hardware logic of the one or more computer processors is designed or redesigned to track memory use at a coarser granularity of a set of frames rather than at a finer granularity of an individual frame. The finer-grained tracking may nevertheless have ceased being used or enabled, for reasons given previously in this disclosure. To track memory use at the coarser granularity, the hardware logic can be designed or redesigned as follows. For a memory object, provided that the operating system has identified the memory object as being a private memory object or a shared memory object, and where the memory object is backed by a set of contiguous frames for which an address translation indicates that a set of a certain size such as two gigabytes is in use, any reference to a memory location in a given set of contiguous frames causes the hardware logic to set the reference bit of the storage key of the first frame in the given set of contiguous frames.

In such a case, the remaining 2047 reference bits for the set having the size of two gigabytes are not used for these purposes and, in some embodiments, are not used at all, according to one embodiment. Further, the address translation can be dynamic address translation (DAT), which is configured to translate a virtual address of a memory reference into a corresponding, real address, according to one embodiment. At least in some embodiments, the hardware logic is agnostic is to whether a memory object is a private memory object, a shared memory object, or a common memory object. The operating system can identify the specific types of memory objects and maintain the DAT table accordingly, while the hardware logic resolves memory accesses based on the DAT table.

For instance, the hardware logic maintains the reference bit in CF 1 of the control fields 166 to reflect memory use across frames 1-N of the set of contiguous frames 164, while CFs 2-N of the control fields 166 are not maintained for this purpose. Doing so effectively overrides any alternative semantic meaning of the maintained reference bit with an overloaded semantic meaning at least in some cases, while in other cases, doing so can at least be contrasted with such an alternative semantic meaning. An example of an alternative semantic meaning of the maintained reference bit can be shown in a scenario in which the hardware logic separately maintains: CF 1 of the control fields 166 to reflect memory use of only frame 1 of the set of contiguous frames 164, CF 2 of the control fields 166 to reflect memory use of only frame 2 of the set of contiguous frames 164, and so forth, up to CF N of the control fields 166 to reflect memory use of only frame N of the set of contiguous frames 164.

Similarly, for a memory object, provided that the operating system has determined the memory object as being a private memory object or a shared memory object, and where the memory object is backed by a set of contiguous frames for which an address translation operation indicates that a set of a certain size such as one megabyte is in use, any reference to a memory location in a given set of contiguous frames causes the hardware logic to set the reference bit of the storage key of the first frame in the given set of contiguous frames. In such a case, the remaining 255 reference bits for the set having the size of one megabyte are not used for these purposes and, in some embodiments, are not used at all.

At least in some embodiments, the finer-grained tracking can be used or enabled only for private memory objects and/or shared memory objects. Further, at least in some embodiments, the finer-grained tracking is not used or enabled for sets of contiguous frames where the sets back regular memory objects, also referred to as common memory objects. The reason is that regular memory objects are likely to be important for troubleshooting purposes and, hence, should be included in diagnostic dumps.

The operating system 180 is configured to evaluate the unreferenced-interval count for sets of contiguous frames, where the sets are desired to be tracked, according to one embodiment. In some embodiments, the evaluation can be performed by a specified component of the operating system 180, such as the logger 188. In the selective-dumping mode, if a given set of contiguous frames has an unreferenced-interval count greater than the predefined threshold, the logger 188 refrains from capturing any frame of the set of contiguous frames. A threshold count of sixty-four has shown useful at least in some cases.

At least in some embodiments, in the selective-dumping mode, the logger 188 maintains an index of skipped sets of contiguous frames, where the index includes identifying attributes of the skipped sets. The index can also be referred to as a ledger. Examples of the identifying attributes include one or more memory addresses and/or a memory size. The one or more memory addresses can include a starting address for the set and/or an ending address for the set. The memory size can represent a size of the set in memory. In an alternative embodiment, rather than maintaining an index of skipped sets of contiguous frames, the logger 188 maintains an index of individual frames that are skipped. In certain other embodiments, no index of skipped sets (or skipped frames) is maintained. In still other embodiments, a separate index of sets (or frames) to be included in the selective diagnostic dump is maintained; doing so permits deferring I/O processing associated with the selective diagnostic dump.

In the dual-dumping mode, the logger 188 writes two diagnostic dumps. For example, the logger 188 can write the selective diagnostic dump and the full diagnostic dump. To write the selective diagnostic dump, the logger 188 captures each set of contiguous frames to the memory area designated as a memory-capture copy-destination, and the unreferenced-interval count is recorded in the metadata associated with the respective set. In this manner, the selective diagnostic dump contains each set whose unreferenced-interval count does not exceed the predefined threshold. In one embodiment, the memory-capture copy-destination includes sets of pages, where the first page in each set stores metadata including attributes of the remaining pages of the respective set. For instance, each page can have a page size of four kilobytes, and each set can include sixty-four pages. The pages of each set are contiguous relative to one another in memory, but the sets themselves need not necessarily be contiguous relative to one another in memory, in some embodiments.

In one embodiment, the logger 188 also writes the full diagnostic dump, which includes each frame of each set of contiguous frames. In some embodiments, the full diagnostic dump is transmitted only when the information contained in selective diagnostic dump proves insufficient for the desired purpose. When a given set of contiguous frames is skipped, the logger 188 updates the index of skipped sets to reflect identifying attributes of the given set of contiguous frames, according to one embodiment.

As such, the techniques herein can also be referred to as techniques for reducing sizes of diagnostic memory dumps, where the sizes are reduced based on coarser-grained tracking of memory use. The memory use is tracked to identify frame candidates for exclusion from a diagnostic memory dump. The frame candidates can be identified based on a least-recently-used criterion. The tracking is coarser-grained because the tracking is performed on a set of contiguous frames as a whole rather than at a finer granularity of each individual frame.

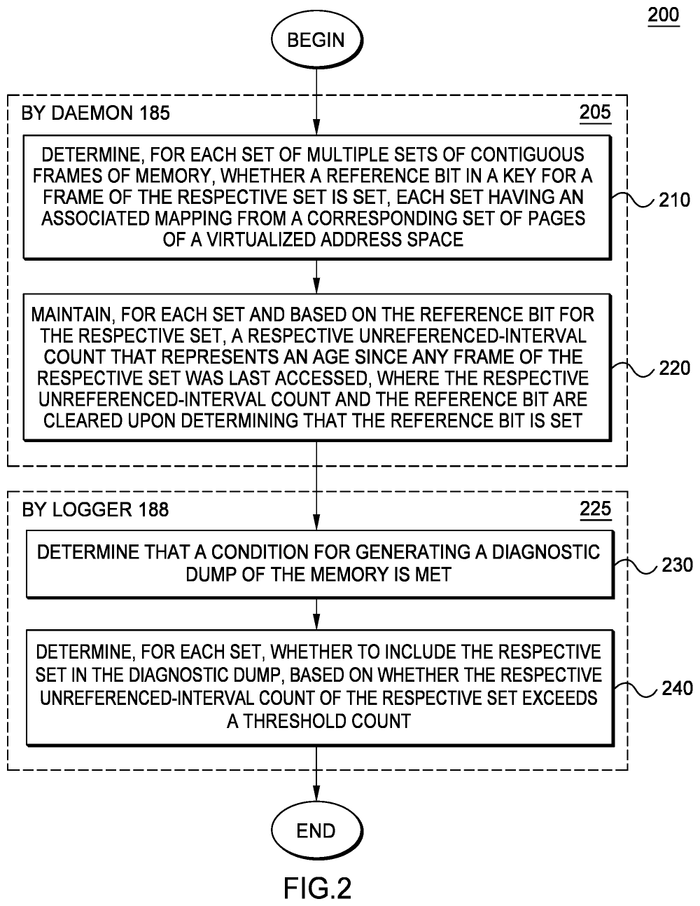

FIG. 2 is a flowchart depicting a method 200 for selective diagnostic dumping of memory contents based on tracking memory use, according to one embodiment. The method 200 can generally be performed by the operating system 180 of FIG. 1. As shown, the method 200 begins at step 210, where the daemon 185 determines, for each set of multiple sets of contiguous frames of memory, whether a reference bit in a key for a frame of the respective set is set.

In one embodiment, each set of contiguous frames has an associated mapping from a corresponding set of pages of a virtualized address space. Within each set, the frames of the respective set are contiguous with respect to other frames in the respective set. Frames of a given set need not necessarily be contiguous with respect to frames from a different set.

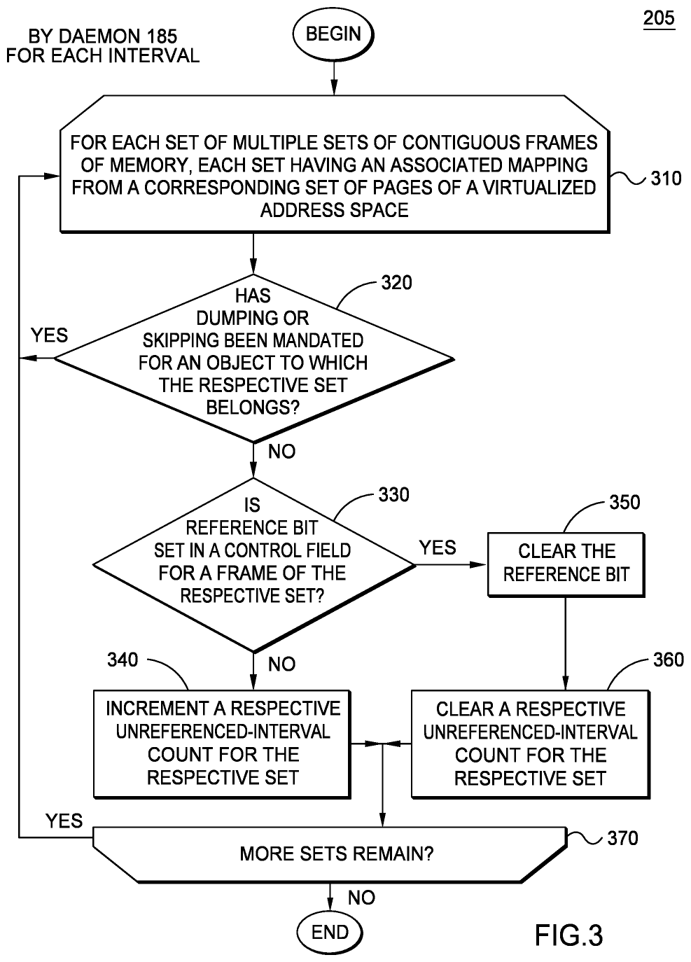

At step 220, the daemon 185 maintains, for each set and based on the reference bit for the respective set, a respective unreferenced interval count that represents an age since any frame of the respective set was last accessed. The respective unreferenced interval count and the reference bit are cleared upon determining that the reference bit is set. A grouping 205 of the steps 210, 220 represents the functionality performed by the daemon 185. The grouping 205 is further described below in conjunction with FIG. 3.

At step 230, the logger 188 determines that a condition for generating a diagnostic dump of the memory is met. Depending on the embodiment, the condition can be satisfied when a request is received by a requestor such as application, middleware, the operating system itself, or users such as operations staff of the computing environment. In certain embodiments, the condition is satisfied when a diagnostic dump is specifically requested based on user input. In some embodiments, the condition can also be satisfied when a given application crashes and/or causes the operating system to crash. In other embodiments, the condition can be satisfied when a given period of time has elapsed since a last time a diagnostic dump was performed.

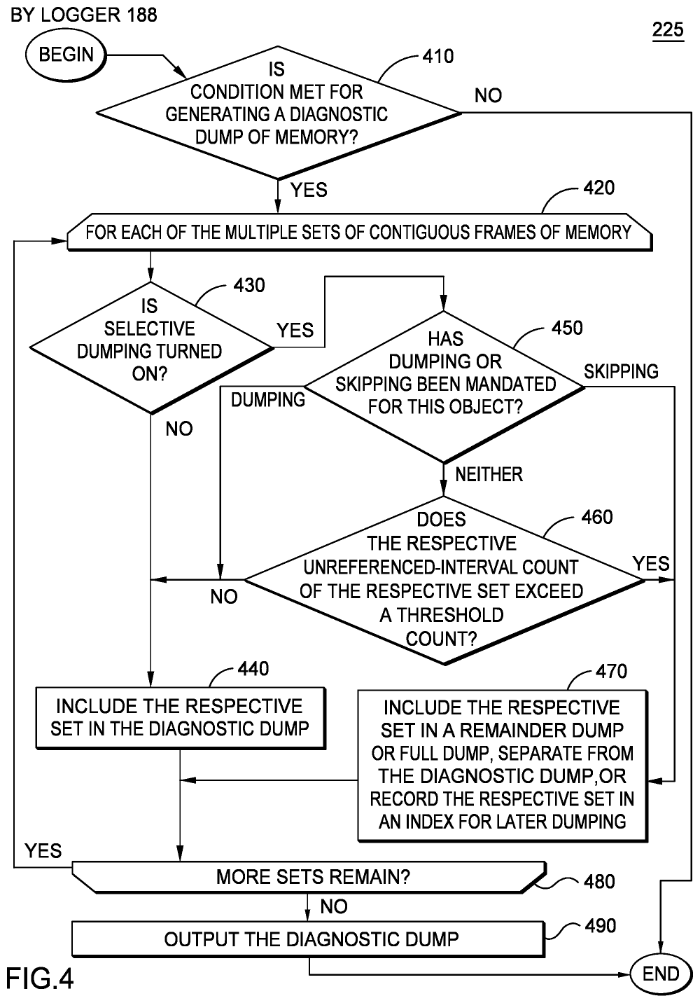

At step 240, the logger 188 determines, for each set, whether to include the respective set in the diagnostic dump, based on whether the respective unreferenced-interval count of the respective set exceeds a threshold count. More specifically, if the threshold count is not exceeded, then the respective set is included in the diagnostic dump; otherwise—i.e., if the threshold count is exceeded—the respective set is excluded from the diagnostic dump. A grouping 225 of the steps 230, 240 represents the functionality performed by the logger 188. The grouping 225 is further described below in conjunction with FIG. 4. After the step 240, the method 200 terminates.

FIG. 3 is a flowchart depicting a method for tracking memory use to facilitate selective diagnostic dumping, according to one embodiment. The method corresponds to the grouping 205 of FIG. 2 and can be performed by the daemon 185 of FIG. 1. As shown, the method begins at step 310, where the daemon 185 enters a loop to process each set of multiple sets of contiguous frames of memory, where this loop can be considered as an inner loop in relation to the earlier-described loop or outer loop. As stated previously, each set has an associated mapping from a corresponding set of pages of a virtualized address space. Inside the (inner) loop, at step 320, the daemon 185 determines whether dumping or skipping has been mandated for an object that the respective set belongs to. If dumping or skipping has been mandated, the method returns to the step 310 to process a next set.

On the other hand, if the daemon 185 determines neither dumping nor skipping has been mandated for the object, the method proceeds to step 330, where the daemon 185 determines whether the reference bit is set in a control field for a frame of the respective set. If so, the daemon 185 clears the reference bit at step 350 and clears a respective unreferenced-interval count for the respective set at step 360. Otherwise, the daemon 185 increments the respective unreferenced-interval count for the respective set at step 340.

At least in some embodiments, the method itself can be, at a specified interval, continually performed or otherwise looped; such a loop can constitute an outer loop relative to the earlier-described loop or inner loop. Depending on the embodiment, the specified interval can be represented based on any measure such as seconds, clock cycles, etc. A specified interval of five seconds has shown useful at least in some cases. After the step 340 or 360, the method proceeds to step 370, where the daemon 185 determines whether any more sets remain to be processed. If so, the method returns to the step 310 to process a next set. Otherwise, the method exits the (inner) loop and terminates at least until an amount of time corresponding to the specified interval has again elapsed.

FIG. 4 is a flowchart depicting a method for selective diagnostic dumping of memory contents based on tracked memory use, according to one embodiment. The method corresponds to the grouping 225 of FIG. 2 and can be performed by the logger 188 of FIG. 1. As shown, the method begins at step 410, where the logger 188 determines whether a condition is met for generating a diagnostic dump of the memory. If the condition is not met, the method terminates. However, if the condition is met, the method proceeds to step 420, where the logger 188 enters a loop to process each of the multiple sets of contiguous frames of memory as designated by a requestor of the diagnostic dump.

Inside the loop, at step 430, the logger 188 determines whether selective dumping, rather than complete dumping, is enabled, according to one embodiment. If selective dumping is not enabled—i.e., if complete dumping is enabled—the method proceeds to step 440, where the logger 188 includes the respective set in the diagnostic dump. On the other hand, if selective dumping is enabled, the method proceeds to step 450, where the logger 188 determines whether dumping or skipping has been mandated for an object that the respective set belongs to. The enabling of dumping or skipping for a specific object should not be confused with the enabling of selective dumping overall; the latter is not specific to any object and applies to all objects.

Further, depending on the embodiment, the mandate can apply at an individual-object level, an object-type level, and/or at object-size level. For instance, a mandate may be present to dump all common system objects, while it may be the case that neither mandate is present for private system objects and shared system objects. Additionally or alternatively, a mandate may be present to dump all objects that occupy frames smaller than the size of the set of the contiguous frames. Such objects can be referred to as discrete objects or smaller objects. In some embodiments, one or more additional flags can be provided to control which level(s) of mandate override which other level(s) of mandate in the cases of conflicting mandates.

In some embodiments, if dumping has been mandated, the logger 188 includes the respective set in the diagnostic dump at step 440. If skipping has been mandated, the logger 188 skips including the respective set in the diagnostic dump. Alternatively, if skipping has been mandated, at step 470, the logger 188 can optionally include the respective set in a remainder diagnostic dump or in a full diagnostic dump, each of which is separate from the diagnostic dump. Additionally or alternatively, at step 470, the logger 188 can optionally record identifying attributes of the respective set in an index of excluded sets; this index can be used if a remainder dump or a full dump is subsequently desired.

Still alternatively, if neither dumping nor skipping has been mandated at step 450, the method proceeds to step 460, where the logger 188 determines whether a respective unreferenced-interval count of the respective set exceeds a threshold count. If the threshold count is not exceeded, the method proceeds to the step 440, where the logger 188 includes the respective set in the diagnostic dump. On the other hand, if the threshold count is exceeded, the logger 188 skips including the respective set in the diagnostic dump; the logger 188 can optionally, at step 470, include the respective set in the remainder dump or full dump or record the respective set in the index.

After the step 440 or 480, the method proceeds to step 480, where the logger 188 determines whether any more sets remain to be processed. If so, the method returns to the step 420 to process a next set. Otherwise, the method exits the loop and proceeds to step 490, where the logger 188 outputs the diagnostic dump. After the step 490, the method terminates.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure is not limited to specific described embodiments. Instead, any combination of the features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages discussed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

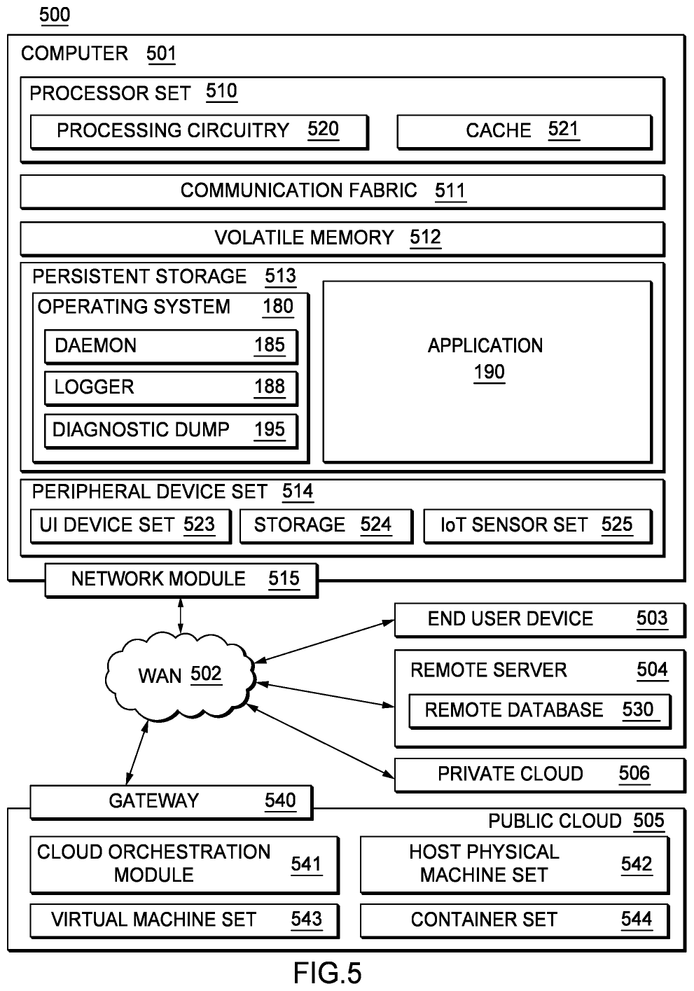

FIG. 5 is a block diagram illustrating components of a computing environment 500 for selective diagnostic dumping of memory contents based on tracking memory use, according to one embodiment. Computing environment 500 contains an example of an environment for the execution of at least some of the computer code involved in performing the inventive methods, such as operating system 180, whose components are configured to perform selective diagnostic dumping of memory contents based on tracking memory use, according to one embodiment. In addition to the operating system 180, computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including the operating system 180, the diagnostic dump 195, and the application 190), peripheral device set 514 (including user interface (UI) device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

COMPUTER 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

PROCESSOR SET 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in operating system 180 in persistent storage 513.

COMMUNICATION FABRIC 511 is the signal conduction path that allows the various components of computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 512 is any type of volatile memory now known or to be developed in the future. Examples include dynamic type random access memory (RAM) or static type RAM. Typically, volatile memory 512 is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

PERSISTENT STORAGE 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid state storage devices. The operating system 180 may take several forms, such as various known proprietary operating systems or open source Portable Operating System Interface-type operating systems that employ a kernel. The operating system 180 includes components such as the daemon 185 and the logger 188. The code included in the operating system 180 typically includes at least some of the computer code involved in performing the inventive methods, including generating the diagnostic dump 195. The application 190 executes in an environment provided by the operating system 180.

PERIPHERAL DEVICE SET 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

NETWORK MODULE 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN 502 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

REMOTE SERVER 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

PUBLIC CLOUD 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

While the foregoing is directed to embodiments of the present invention, other and further embodiments of the invention may be devised without departing from the basic scope thereof, and the scope thereof is determined by the claims that follow.

What is claimed is:

1. A computer-implemented method of selective memory dumping based on tracking memory use, the computer-implemented method comprising:
determining, by a program and for each of a plurality of sets of contiguous frames of memory, whether a reference bit is set, wherein the reference bit is included in a control field for a frame of the respective set, each set having an associated mapping from a corresponding plurality of pages of a virtualized address space;
maintaining, for each of the plurality of sets of contiguous frames and based on the reference bit for the respective set, an unreferenced-interval count that represents an age since any frame of the respective set was last accessed, wherein the unreferenced-interval count and the reference bit are cleared by the program upon determining that the reference bit is set;
determining, by one or more computer processors, that a condition for generating a diagnostic dump of the memory is met; and
upon determining that the unreferenced-interval count of a first set of the plurality of sets does not exceed a threshold count, including the first set in the diagnostic dump.

2. The computer-implemented method of claim 1, wherein the program is configured to, upon a determination that the unreferenced-interval count of a second set of the plurality of sets exceeds the threshold count, exclude the second set from the diagnostic dump.

3. The computer-implemented method of claim 1, wherein the program comprises an operating system, wherein that the condition is met is determined by the operating system, and wherein the first set is included in the diagnostic dump by the operating system.

4. The computer-implemented method of claim 1, wherein the reference bit in the control field for the frame of the respective set is set by hardware logic of the one or more computer processors, without intervention by the program, whenever any frame of the respective set is accessed.

5. The computer-implemented method of claim 1, further comprising:
updating an index of sets excluded from the diagnostic dump, wherein the index is updated to reflect page addresses corresponding to the second set.

6. The computer-implemented method of claim 1, wherein the unreferenced-interval count is maintained by determining, at a predefined interval and based on the reference bit, whether to increment or clear the unreferenced-interval count.

7. The computer-implemented method of claim 1, wherein each frame of the set is associated with a respective control field that includes a respective reference bit, wherein the reference bit of the frame is used in tracking frame access of the set, and wherein each reference bit other than the reference bit of the frame is unused in the tracking of frame access of the set.

8. The computer-implemented method of claim 1, wherein the unreferenced-interval count of a third set of the plurality of sets is not maintained, upon a determination that the plurality of pages corresponding to the third set are of a memory object for which an option to mandate dumping is enabled or an option to mandate skipping is enabled.

9. The computer-implemented method of claim 1, wherein the program comprises an operating system, the operating system having a plurality of components including a daemon and a logger, wherein the unreferenced-interval count is maintained by determining, by the daemon at a predefined interval and based on the reference bit, whether to increment or clear the unreferenced-interval count, and wherein the diagnostic dump is generated by the logger;
wherein each frame of the set is associated with a respective control field that includes a respective reference bit, wherein each reference bit other than the reference bit of the frame is unused in tracking frame access of the set;
wherein the unreferenced-interval count of a third set of the plurality of sets is not maintained, upon a determination that the plurality of pages corresponding to the third set are of a memory object for which an option to mandate dumping is enabled or an option to mandate skipping is enabled.

10. The computer-implemented method of claim 9, further comprising:
determining that the virtualized address space is of at least a threshold size;
updating an index of sets excluded from the diagnostic dump, wherein the index is updated to reflect page addresses corresponding to the second set;
transmitting the diagnostic dump;
generating an additional diagnostic dump that includes both of the first and second sets; and
responsive to a request subsequent to transmission of the diagnostic dump, transmitting the additional diagnostic dump.

11. A computer program product of selective memory dumping based on tracking memory use, the computer program product comprising:
a computer-readable storage medium having computer-readable program code embodied therewith, the computer-readable program code executable by one or more computer processors to perform an operation comprising:
determining, for each of a plurality of sets of contiguous frames of memory, whether a reference bit is set, wherein the reference bit is included in a control field for a frame of the respective set each set having an associated mapping from a corresponding plurality of pages of a virtualized address space;
maintaining, for each of the plurality of sets of contiguous frames and based on the reference bit for the respective set, an unreferenced-interval count that represents an age since any frame of the respective set was last accessed, wherein the unreferenced-interval count and the reference bit are cleared upon determining that the reference bit is set;
determining that a condition for generating a diagnostic dump of the memory is met; and
upon determining that the unreferenced-interval count of a first set of the plurality of sets does not exceed a threshold count, including the first set in the diagnostic dump.

12. The computer program product of claim 11, wherein the computer-readable program code is of a program configured to, upon a determination that the unreferenced-interval count of a second set of the plurality of sets exceeds the threshold count, exclude the second set from the diagnostic dump.

13. The computer program product of claim 11, wherein the computer-readable program code is of a program that comprises an operating system, wherein that the condition is met is determined by the operating system, and wherein the first set is included in the diagnostic dump by the operating system.

14. The computer program product of claim 11, wherein the reference bit in the control field for the frame of the respective set is set by hardware logic of the one or more computer processors, without intervention by a program containing the computer-readable program code, whenever any frame of the respective set is accessed.

15. The computer program product of claim 11, the operation further comprising:
updating an index of sets excluded from the diagnostic dump, wherein the index is updated to reflect page addresses corresponding to the second set.

16. A system of selective memory dumping based on tracking memory use, the system comprising:
one or more computer processors; and
a memory containing a program executable by the one or more computer processors to perform an operation comprising:
determining, for each of a plurality of sets of contiguous frames of memory, whether a reference bit is set, wherein the reference bit is included in a control field for a frame of the respective set each set having an associated mapping from a corresponding plurality of pages of a virtualized address space;
maintaining, for each of the plurality of sets of contiguous frames and based on the reference bit for the respective set, an unreferenced-interval count that represents an age since any frame of the respective set was last accessed, wherein the unreferenced-interval count and the reference bit are cleared upon determining that the reference bit is set;
determining that a condition for generating a diagnostic dump of the memory is met; and
upon determining that the unreferenced-interval count of a first set of the plurality of sets does not exceed a threshold count, including the first set in the diagnostic dump.

17. The system of claim 16, wherein the program is configured to, upon a determination that the unreferenced-interval count of a second set of the plurality of sets exceeds the threshold count, exclude the second set from the diagnostic dump.

18. The system of claim 16, wherein the program comprises an operating system, wherein that the condition is met is determined by the operating system, and wherein the first set is included in the diagnostic dump by the operating system.

19. The system of claim 16, wherein the reference bit in the control field for the frame of the respective set is set by hardware logic of the one or more computer processors, without intervention by the program, whenever any frame of the respective set is accessed.

20. The system of claim 16, the operation further comprising:
updating an index of sets excluded from the diagnostic dump, wherein the index is updated to reflect page addresses corresponding to the second set.
